(19) United States
(12) Patent Application Publication
(10) Pub. No.: US 2013/0097198 A1
(43) Pub. Date: Apr. 18, 2013

(54) BUSINESS ACTIVITY MONITORING RUNTIME

(71) Applicants: Janaki Ram Goteti, Hyderabad (IN); Rajat Talwar, Gurgaon (IN); Kiran Kumar Kolli, Guntur (IN); Tapas Kumar Nayak, Hyderabad (IN)

(72) Inventors: Janaki Ram Goteti, Hyderabad (IN); Rajat Talwar, Gurgaon (IN); Kiran Kumar Kolli, Guntur (IN); Tapas Kumar Nayak, Hyderabad (IN)

(73) Assignee: MICROSOFT CORPORATION, Redmond, WA (US)

(21) Appl. No.: 13/272,246

(22) Filed: Oct. 13, 2011

(51) Int. Cl. G06F 17/30

(52) U.S. Cl. 707/769; 707/E17.014

(57) ABSTRACT

Systems and methods for monitoring business applications are disclosed. Data is provided from an application programming interface (API) in a monitored application to a collection runtime. The collection runtime collects data based upon a data collection model. A current time increment is assigned to the collected data. The collected data is provided as a stream of event data to an event processing service, which performs one or more queries on the data stream. The results of the queries are provided to a data store and/or to a user interface. The data collection model is created from a data collection profile, and the queries are created from an observation model.

### BACKGROUND

A business activity monitoring (BAM) application comprises one or more business models, which can include process models, analytic models, rules, and the like. These business models are created and saved using various modeling tools upon which the models can be implemented using a variety of existing applications. Conventionally, business applications include one or more related models and, optionally, partial or full implementations of the respective models. Additionally, business applications can go through a governance step in which their constituent models and changes to such models are reviewed by appropriate authorities, executives, etc., and approved or denied. Subsequent to approval, the business application is published, and the constituent models of the published business application and their respective implementations are then validated for completeness and consistency.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, data is provided from an application programming interface (API) in a monitored application to a collection runtime. The collection runtime collects data based upon a data collection model. A current time increment is assigned to the collected data. The collected data is provided as a stream of event data to an event processing service, which performs one or more queries on the data stream. The results of the queries are provided to a data store and/or to a user interface. The data collection model is created from a data collection profile, and the queries are created from an observation model.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a high level block diagram of a business activity monitoring (BAM) service;

FIG. 2 illustrates components of an event processing (EP) service in one embodiment of a BAM runtime;

FIG. 3 is a flowchart outlining a process for monitoring a business application according to one embodiment;

FIG. 4 is a flowchart outlining a process for using data collection models according to one embodiment;

FIG. 5 is a flowchart outlining a process for generating a query model according to one embodiment; and

FIG. 6 illustrates an example of a suitable computing and networking environment on which the examples of FIGS. 1-5 may be implemented.

### DETAILED DESCRIPTION

Business activity monitoring (BAM) provides an infrastructure for monitoring business activities for business processes. Part of the infrastructure is an execution layer that collects events emitted by applications and then computes interesting events and KPIs (key performance indicators) based on an intent modeled by business users. Raw events emitted by application components are modeled as streams of events, with events having a lifetime that is used in computations. Streams also have a notion of current time increment (CTI) that may be inferred or computed.

In one embodiment, an application programming interface (API) is used by applications to emit events. Once events are emitted, an event processor collects those events and transforms them to a stream of events depending on KPIs of interest.

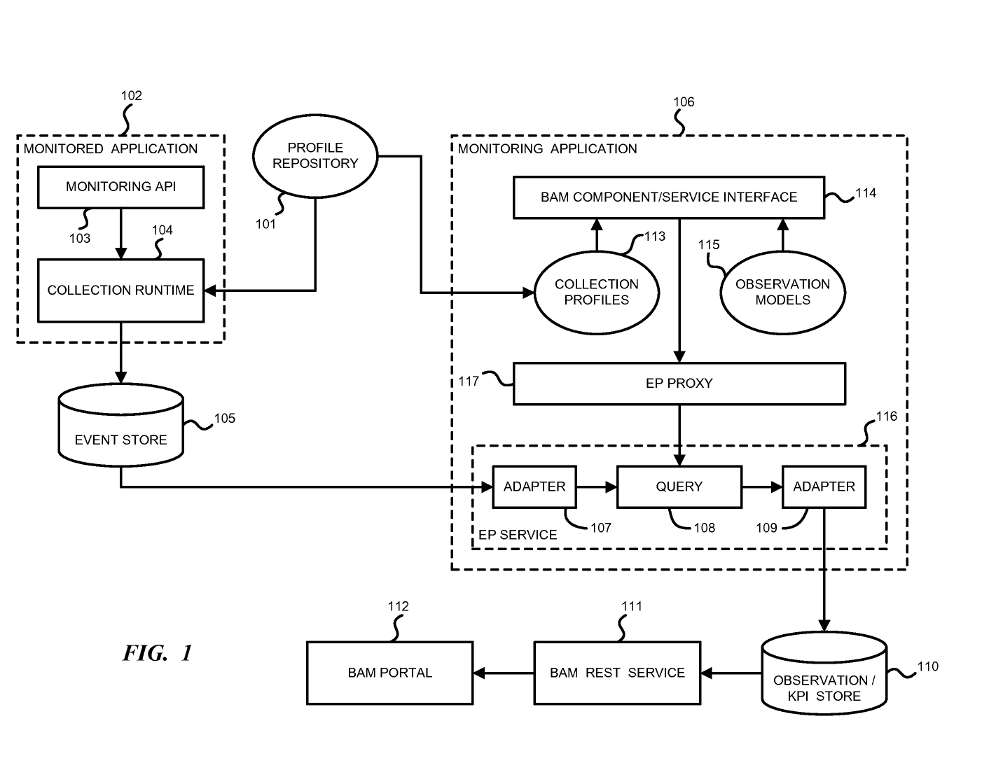

FIG. 1 is a high level block diagram of a business activity monitoring (BAM) service. Profile repository 101 holds models for the collection of data. These models identify what data is of interest and how to collect that data. The data collection model identifies where/what/how data can be collected from a user's business application. For example, if the monitored application is an ordering process, the model may identify what order and customer information should be collected and how to collect such data.

The model is applied to a user's monitored application 102, which may be a business application, a website, or any code of interest. Monitoring API 103 monitors code calls in application 102. Monitoring API 103 identifies and tracks data in the monitored application 102.

Collection runtime 104 reads the model from profile repository 101 to identify the data of interest. Collection runtime 104 collects the data from monitoring API 103 and then selects relevant data as identified by the model. In this way, the monitoring API 103 itself does not need to be modified to collect specific data of interest. Instead, the model is used in collection runtime 104 to determine what data is of interest.

Collection runtime 104 creates a stream of data that is collected in event store 105. The data in the event store is processed by a monitoring application 106. Different event stores 105 may be used for different monitored applications, or a single event store 105 may hold data for multiple applications 102. A separate monitoring application 106 may be used for each user or each monitored application 102.

Input adapter 107 in monitoring application 106 communicates with one or more event stores 105. There may be a number of different types of event stores 105, such as different databases, and input adapter 107 is configured to communicate with and to pull data from each type of event store 105. Input adapter 107 converts or modifies the data from event store 105 as necessary and provides the data to query module 108.

Query module 108 performs computations and queries on the data collected from monitored application 102. The results of those computations and queries are provided to output adapter 109.

Output adapter 109 communicates with one or more observation/KPI stores 110. There may be a number of different types of observation/KPI stores 110, such as different databases. Output adapter 109 is configured to communicate with and to push data to each type of observation/KPI store 110. Output adapter 110 converts or modifies the data from query module 108 as necessary and provides the output of the computations to observation/KPI store 110.

BAM REST (Representational State Transition) service 111 provides user access to the data stored in observation/KPI store 110. BAM REST service 111 provides tools for displaying and/or further analyzing the data output from query module 108. BAM REST service 111 may display the data in a format requested by a user. In one embodiment, BAM REST service 111 provides a data feed, such as an RSS feed, comprising the output of query module 108.

BAM portal 112 provides an additional output for the compute data. In one embodiment, BAM portal 112 enhances, organizes, or refines the data output from BAM REST service 111 and displays the data to the user. For example, BAM portal 112 may use the data from BAM REST service 111 and create a graph, table or other enhanced display for the user. In other embodiments, BAM portal 112 may provide an interface that allows users to retrieve selected data from observation/KPI store 110, such as data from a certain period or for a particular monitored application 102.

Monitoring application 102 may further comprise collection profiles 113 that define parameters for data collection—such as the what/where/when of data collection. These collection profiles 113 may be based upon the data collection models that are stored in profile repository 101.

BAM component/service interface 114 accesses the collection profiles 113 and observation models 115. BAM component/service interface 114 uses EP proxy 117 to create queries for query module 108.

Query module 108 along with input adapter 107 and output adapter 109 may be part of an event processing (EP) service 116 using a stream processing architecture. Event streams from collection runtime 104 via event store 105 are processed by EP service 116. The streams may represent data collected from business applications, such as manufacturing and financial trading applications or Web and operational analytics. EP service 116 computes or queries data from the event stream to identify patterns, KPIs, trends, exceptions, and alerts. In one embodiment, EP service 116 may use a MICROSOFT STREAMINSIGHT™ platform.

EP proxy 117 creates queries for query module 108 based upon the observation models 115. Computations in the observation model 115 may be transformed into queries that are applied by query module 108 against the data stream from event store 105.

The stream of data output from collection runtime 104 to event store 105 and then to EP service 116 is associated with the time when the data is generated and is associated with a current time indicator (CTI). This data may be partitioned in order to scale-up processing, such as to handle larger volumes of events. EP service 116 and query module 108 may handle the partitioning of the data stream.

Monitoring application 106 may comprise a plurality of EP services 116 and computes 108. Different partitions within the data stream may be routed to different computes 108. The query module 108 may be selected based upon the user or parameters in the model.

In one embodiment, query module 108 may be a join compute that collects data from different monitored applications 102 and joins related data together. For example, in a business process there may be separate applications for ordering goods, preparing shipments for ordered goods, and processing credit cards for purchases of the goods. Models in profile repository 101 are used by a monitoring API 103 and collection runtime 104 to collect relevant data from these different applications. The data collected from these applications is streamed to a join query module 108, which joins the related data together. The joined data may be further processed in an analysis query module 108 and/or displayed to the user via BAM REST service 111 or BAM portal 112.

The BAM service illustrated in FIG. 1 is highly scalable. All of the components in monitoring application 106 may be performed on a single server or they may each be performed on separate servers.

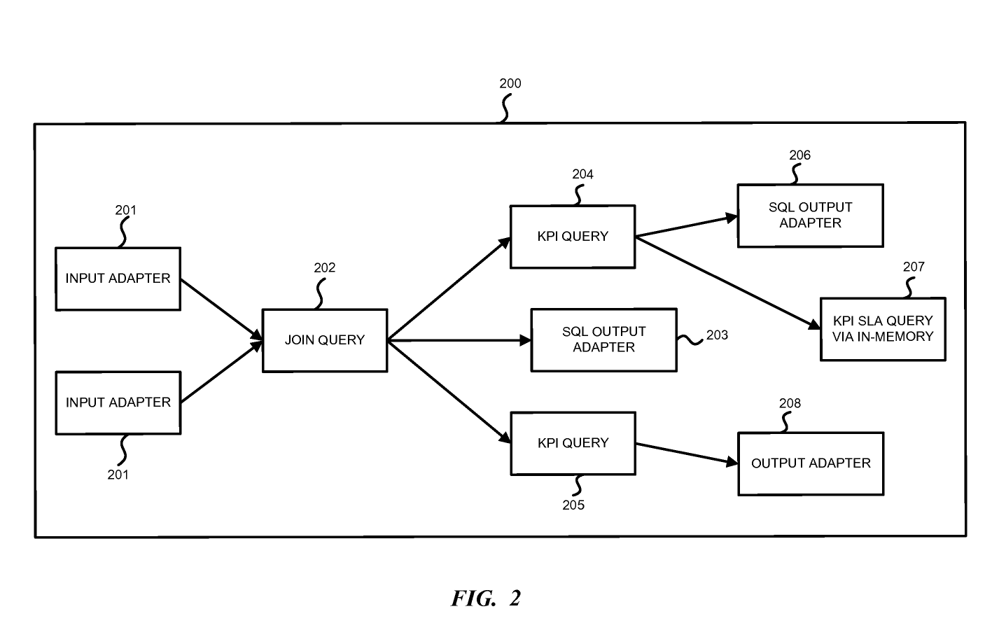

FIG. 2 illustrates components of an event processing (EP) service 200 in one embodiment of a BAM runtime. Input adaptors 201 receive data or event streams. There may be a plurality of input adaptors 201 in the EP service with each adaptor configured to operate with a different data source. Input adaptors 201 may be coupled to a collection runtime in a monitored application or to an event store. Input adaptors 201 transform the received data or event stream into a format that is useable by query 202.

In the embodiment illustrated in FIG. 2, query 202 is a join query. However, it will be understood that query may be any type of query, such as an analysis, KPI or observation/model (OM) query. Join query 202 receives a formatted input from input adaptors 201 and performs a join compute on the data stream. In one embodiment, different sets of data from different applications are combined in the join query 202. The data may be joined based on a particular user, application or CTI.

Join query 202 provides the results of its compute to output adaptor 203. In one embodiment, output adaptor 203 is configured to provide the data from join query 202 to a SQL server. It will be understood that output adaptor 203 may alternatively be configured to provide an output to another server or to other code for further processing.

The output of join query 202 may be provided to a single destination or to multiple sources. For example, the output of join query 202 may also be routed to KPI query 204 and KPI query 205 for further processing. The output of KPI query 204 may be provided to an output adaptor, such as SQL output adaptor 206, or to another KPI query, such as KPI SLA (service level agreement) query 207. Instead of using an output adapter, the data from a query may be transferred in-memory as illustrated in 207.

The output of the KPI query 205 may be provided to another output adapter 208 that routes the data to an observation/KPI store, BAM REST service, or BAM portal where it may be accessed by a user.

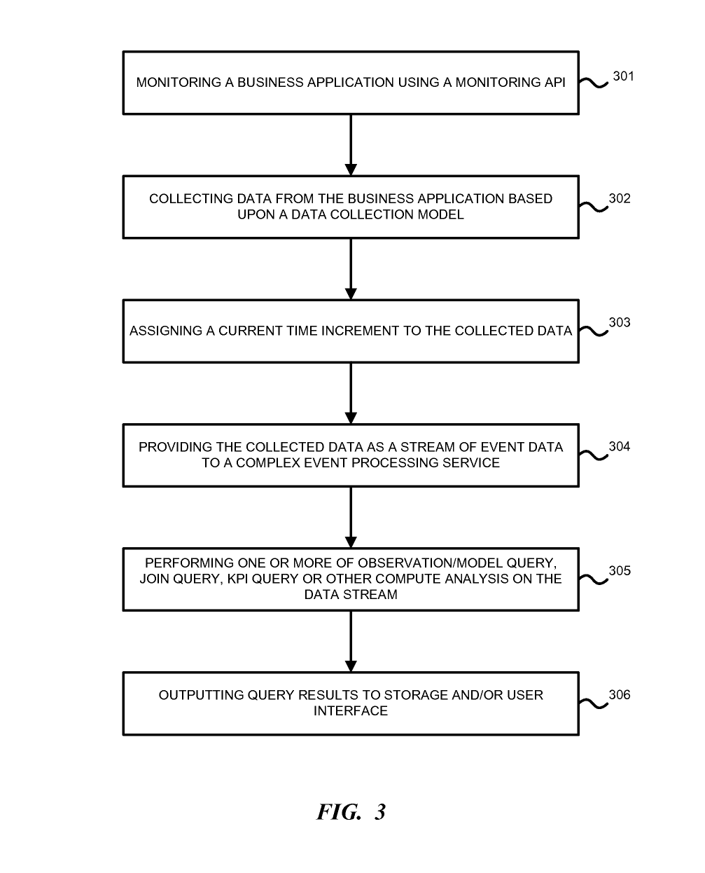

FIG. 3 is a flowchart outlining a process for monitoring a business application according to one embodiment. In step 301, the business application is monitored by an API that provides data to a collection runtime. In step 302, the collection runtime collects data from the business application based upon a data collection model. The data collection model identifies what data to collect, how to collect the data, and when to collect the data. The collected data is assigned a current time increment in step 303.

In step 304, the collected data is provided to an event processing service as a stream of event data. The stream of event data may be associated with a current time increment (CTI). The event data may be transformed by an input adapter in one embodiment before it reaches the event processor. In step 305, the event processing service performs one or more queries on the event data stream. The queries may be observation/model queries, join queries, KPI queries, or any other analysis. In step 306, the results of the query are provided to a data store and/or a user interface. The result data may be transformed by an output adapter in one embodiment before it reaches the data store or user interface. The user interface may be a BAM REST service and/or a BAM portal, for example.

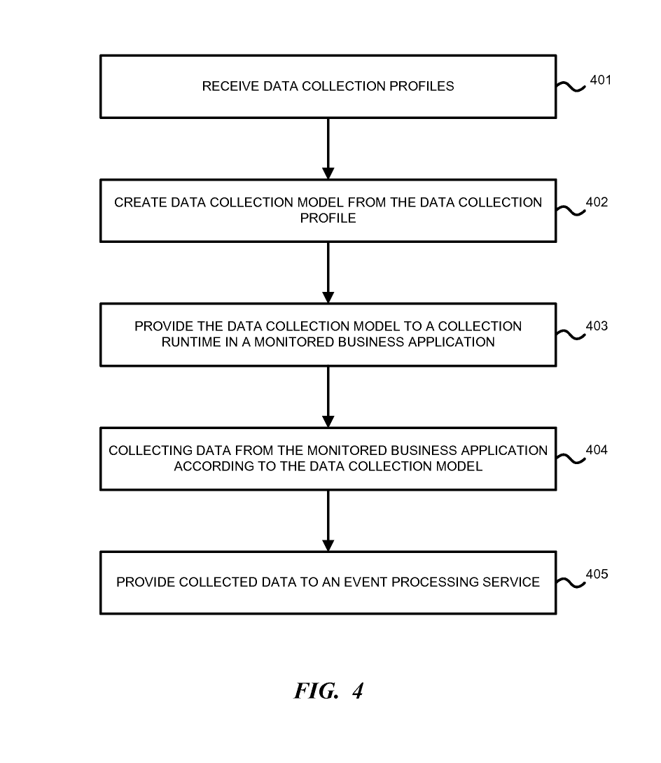

FIG. 4 is a flowchart outlining a process for using data collection models according to one embodiment. In step 401, a data collection profile is received from a user or other source. In step 402, a data collection model is created from the data collection profile. The data collection model identifies data to be collected from a business application and the manner and time of such data collection. In step 403, the data collection model is provided to a collection runtime in a monitored business application.

In step 404, the collection runtime collects data from the monitored business application according to the data collection model. The collection runtime may apply the data collection model to data provided from a monitoring API in the business application. In step 405, the collected data is provided from the collection runtime to an event processing service. The data may be provided as an event stream. Data in the event stream may be associated with a current time increment.

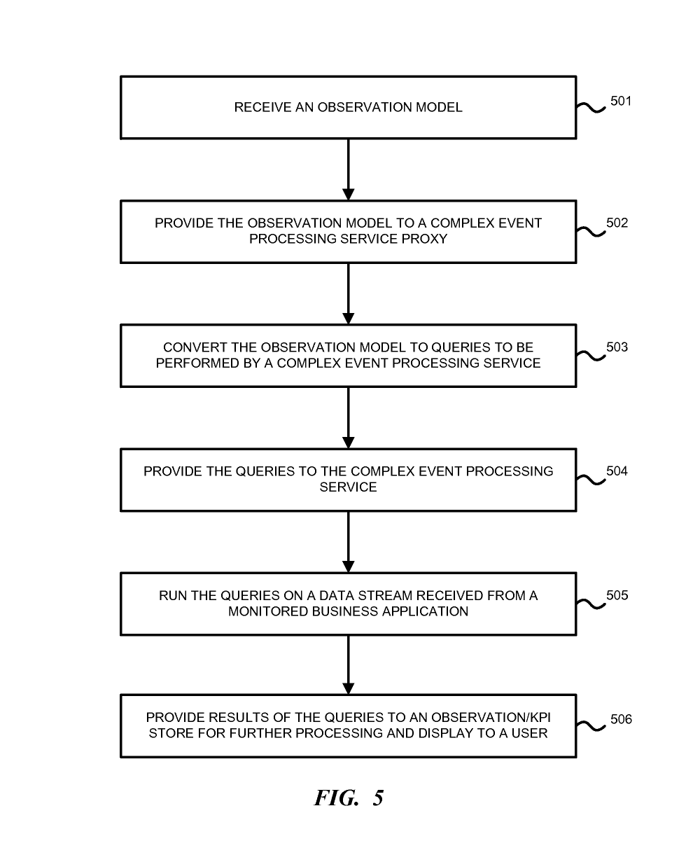

FIG. 5 is a flowchart outlining a process for generating a query model according to one embodiment. In step 501, an observation model is received from a user or other source. In step 502, the observation model is provided to an event processing proxy. In step 503, the event processing proxy converts the observation model to queries that can be performed by an event processing service.

In step 504, the queries are provided to the event processing service. The event processing service receives a data stream from a collection runtime on a monitored business application. In step 505, the queries are run on the data stream. The results of the queries are provided to an observation/KPI store for further processing and display to a user in step 506.

It will be understood that the steps shown in the processes illustrated in FIGS. 3-5 may be executed simultaneously and/or sequentially. It will be further understood that each step may be performed in any order and may be performed once or repetitiously.

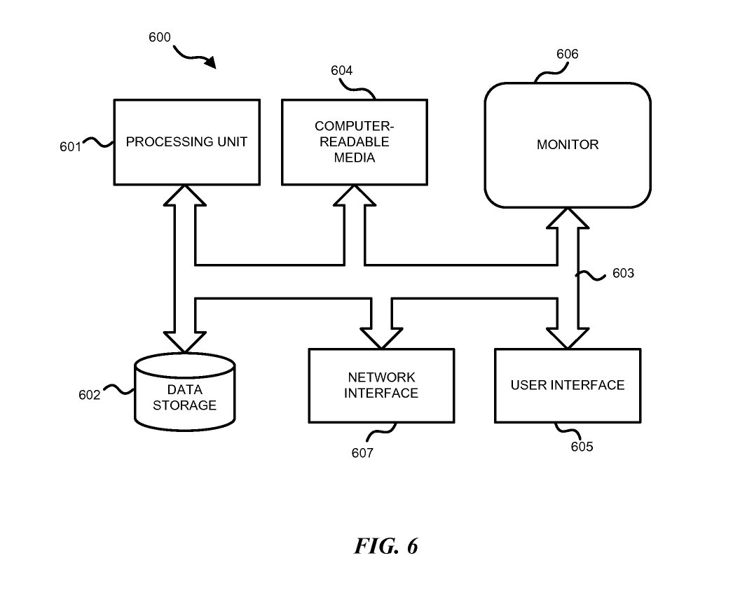

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the invention. The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 600. Components may include, but are not limited to, processing unit 601, data storage 602, such as a system memory, and system bus 603 that couples various system components including the data storage 602 to the processing unit 601. The system bus 603 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 600 typically includes a variety of computer-readable media 604. Computer-readable media 604 may be any available media that can be accessed by the computer 601 and includes both volatile and nonvolatile media, and removable and non-removable media. By way of example, and not limitation, computer-readable media 604 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 600. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The data storage or system memory 602 includes computer storage media in the form of volatile and/or nonvolatile memory such as read only memory (ROM) and random access memory (RAM). A basic input/output system (BIOS), containing the basic routines that help to transfer information between elements within computer 600, such as during start-up, is typically stored in ROM. RAM typically contains data and/or program modules that are immediately accessible to and/or presently being operated on by processing unit 601. By way of example, and not limitation, data storage 602 holds an operating system, application programs, and other program modules and program data.

Data storage 602 may also include other removable/non-removable, volatile/nonvolatile computer storage media. By way of example only, data storage 602 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 6, provide storage of computer-readable instructions, data structures, program modules and other data for the computer 600.

A user may enter commands and information through a user interface 605 or other input devices such as a tablet, electronic digitizer, a microphone, keyboard, and/or pointing device, commonly referred to as mouse, trackball or touch pad. Other input devices may include a joystick, game pad, satellite dish, scanner, or the like. These and other input devices are often connected to the processing unit 601 through a user input interface 605 that is coupled to the system bus 603, but may be connected by other interface and bus structures, such as a parallel port, game port or a universal serial bus (USB). A monitor 606 or other type of display device is also connected to the system bus 603 via an interface, such as a video interface. The monitor 606 may also be integrated with a touch-screen panel or the like. Note that the monitor and/or touch screen panel can be physically coupled to a housing in which the computing device 600 is incorporated, such as in a tablet-type personal computer. In addition, computers such as the computing device 600 may also include other peripheral output devices such as speakers and printer, which may be connected through an output peripheral interface or the like.

The computer 600 may operate in a networked environment using logical connections 607 to one or more remote computers, such as a remote computer. The remote computer may be a personal computer, a server, a router, a network PC, a peer device or other common network node, and typically includes many or all of the elements described above relative to the computer 600. The logical connections depicted in FIG. 6 include one or more local area networks (LAN) and one or more wide area networks (WAN), but may also include other networks. Such networking environments are commonplace in offices, enterprise-wide computer networks, intranets and the Internet.

When used in a LAN networking environment, the computer 600 may be connected to a LAN through a network interface or adapter 607. When used in a WAN networking environment, the computer 600 typically includes a modem or other means for establishing communications over the WAN, such as the Internet. The modem, which may be internal or external, may be connected to the system bus 603 via the network interface 607 or other appropriate mechanism. A wireless networking component such as comprising an interface and antenna may be coupled through a suitable device such as an access point or peer computer to a WAN or LAN. In a networked environment, program modules depicted relative to the computer 600, or portions thereof, may be stored in the remote memory storage device. It may be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A business activity monitoring system, comprising:
a collection runtime component configured to collect data from a monitored business application according to a data collection model and to provide the collected data as an event stream; and
an event processing component configured to run queries on the event stream, the queries determined by an observation model.

2. The business activity monitoring system of claim 1, further comprising:
an event processing proxy component adapted to transform the observation model in to queries.

3. The business activity monitoring system of claim 1, further comprising:
an event store coupled to the collection runtime component, the event store adapted to store data in the event stream.

4. The business activity monitoring system of claim 1, further comprising:
an application programming interface (API) monitoring the business application for data to be collected by the collection runtime.

5. The business activity monitoring system of claim 1, further comprising:
a representational state transition (REST) service coupled to the event processing component and adapted to provide an output of the event processing component to one or more users.

6. The business activity monitoring system of claim 5, further comprising:
a portal coupled to the REST service, the portal adapted to convert an output of the REST service into a modified format for one or more users. The business activity monitoring system of claim 5, further comprising:
an output data store coupled to the event processing component and to the REST service, the output data store receiving observation and key performance indicators (KPIs) from queries in the event processing component.

7. The business activity monitoring system of claim 1, wherein the data collection model identifies at least one of a type of data to be collected, a manner in which data is to be collected, and a time at which data is to be collected.

8. The business activity monitoring system of claim 1, wherein the queries are selected from the group consisting of: join queries, analysis queries, key performance indicator queries, and observation model queries.

9. The business activity monitoring system of claim 1, wherein event stream data is associated with a current time increment.

10. A method for monitoring a business activity, comprising:
defining one or more data collection models;
collecting data from a monitored application based upon the data collection models;
providing the collected data as an event stream to a monitoring application;
running queries on the event stream in the monitoring application, the queries based upon an observation model; and
providing results of the queries to a data store.

11. The method of claim 10, further comprising:
collecting the data from the monitored application using a collection runtime operating on the monitored application.

12. The method of claim 10, further comprising:
receiving data collection profiles; and
defining the data collection models from the data collection profiles.

13. The method of claim 10, further comprising:
receiving an observation model; and
converting the observation model to queries using an event processing service proxy.

14. The method of claim 10, further comprising:
providing the results of the queries from the data store to a representational state transition (REST) service, the REST service adapted to provide an output of the event processing component to one or more users.

15. The method of claim 14, further comprising:
providing the results of the queries to a portal coupled to the REST service, the portal adapted to convert an output of the REST service into a modified format for one or more users.

16. The method of claim 10, wherein the results of the queries are key performance indicators (KPIs).

17. The method of claim 10, wherein the queries are selected from the group consisting of: join queries, analysis queries, key performance indicator queries, and observation model queries.

18. The method of claim 10, wherein the event stream data is associated with a current time increment.

19. A method for monitoring a business application, comprising:
providing data from an application programming interface (API) to a collection runtime associated with the business application;
collecting data at the collection runtime based upon a data collection model;
assigning a current time increment to the collected data;
providing the collected data as a stream of event data to an event processing service;
performing one or more queries on the data stream; and
outputting the results of the queries to a user interface.

20. The method of claim 19, further comprising:
creating the data collection model from a data collection profile; and
creating the queries from an observation model.
